(19) United States
(12) Patent Application Publication
(10) Pub. No.: US 2007/0196234 A1
(43) Pub. Date: Aug. 23, 2007

(54) Urine collection and drug testing cup

(76) Inventor: Blane Huff, Loveland, CO (US)

Correspondence Address: BUHLER ASSOCIATES;BUHLER, KIRK A., 1101 CALIFORNIA AVE., SUITE 208, CORONA, CA, 92881, US

(21) Appl. No.: 11/787,395

(22) Filed: Apr. 17, 2007

Related U.S. Application Data
(63) Continuation-in-part of application No. 11/233,866, filed on Sep. 22, 2005.

(51) Int. Cl. B01L 3/00

(52) U.S. Cl. 422/61; 422/102

(57) ABSTRACT

A body fluid collection and assay device that allows for the collection, testing, diagnostics, evaluation, analysis of the fluid within the device. The assaying device includes a handle for easier transportation by one person. A fluid transfer vent is located on a wall within the cup to limit the amount of sample that transfers from the collection portion of the cup to the testing portion of the cup. The assaying device further incorporates an angled base that allows the cup to sit on a table or shelf in a reclined orientation allowing for easier viewing of the assaying strip(s). The collection container incorporates a front viewing window that allows the results of the testing to be viewed through. The collection container device further allows for a screw-down lid that can be placed onto the container to keep the fluid within the cup from spilling.

### CROSS REFERENCE TO RELATED APPLICATION

This application is a continuation-in-part of applicant's co-pending application Ser. No. 11/233,866 filed Sep. 22, 2005 the entire contents of which is hereby expressly incorporated by reference herein.

### FIELD OF THE INVENTION

This invention relates to a fluid collection cup for testing fluids. More particularly, the present invention relates to a fluid collection cup designed for the collection of urine for testing for the presence of drugs or other abnormality in the urine. Even more specifically the collection cup incorporates an angled base, viewing window and a handle, to aid in the collection and viewing of the diagnostic media. The cup further incorporates a novel fluid transfer passage from the collection portion of the cup to the assay test strip.

### BACKGROUND OF THE INVENTION

Drug testing has become a standard method of screening candidates for employment. One of the easiest and most common methods is to require the candidate to supply a urine sample. The urine sample can be used to determine the presence or absence of a variety of drugs including THC, AMP, methamphetamines, morphine, cocaine, PCP, amphetamine, marijuana, opiates and others. The testing is performed by collecting a urine sample and placing one or more assaying strips into the urine sample to perform the test. This can be performed in a physician's office, police station, employment office, company or nearly any location. Patents have been issue on collection and or drug testing cups to perform this function

U.S. Pat. No. 5,976,895 issued to Cipkowski, U.S. Pat. No. 6,730,268 issued to Lee et al., U.S. Pat. Nos. 6,805,837, 6,805,838 both issued to Tydings and U.S. published application 2002/0085953 by Parker disclose fluid testing cups. The collection or sample testing cups disclosed in these patents all describe an essentially round tapered cup with the ability to accept an analysis test strip. None of these patents disclose a handle incorporated into the side of the collection cup. These patents further do not disclose that at least one side of the collection cup is angled back to allow easier viewing and evaluation of the results of the sample being tested. The sides of all the documents disclosed further provide that the cup is round in shape and while the evaluation of the testing can be viewed through the side of the cup and there is no flat window that allows easier viewing of the testing. Some of these patents disclosed that the test strip(s) are placed in an arched fashion around the inside of the cup to reduce the parallax effect created by a curved window.

U.S. Pat. No. 6,485,438 issued to Minue, and published application US2002/169395 by Huang discloses a collection cup with an integrated handle. Neither of these applications discloses that the analysis of the fluid within the cup can be tested within the cup, and both require that the fluid that is collected be transferred in to another container for analysis. The sides of these cups are round in shape, and while the evaluation of the testing can be viewed through the side of the cup, if they were transparent, there is no flat window that allows easier viewing of the testing.

Current testing methods us a wick that draws test liquid from the cup up or down the assay strip to test for drugs in the sample. Other methods use a card having one side that is liquid impervious side and another side that draws the sample onto the assay test strip. None of the testing methods use a closed testing portion of the cup that uses the head pressure of the liquid to fill and limit the amount of liquid that is transferred to the test portion of the cup.

What is needed is a collection cup that has an integrated handle, retaining mechanism for a test strip, a flat viewing window, and that the viewing window is tilted back for easier viewing and further includes a sealed assay testing portion. The proposed urine collection and drug testing cup provides this solution by providing a collection cup with an integrated handle, viewing window, angled base to ease viewing, and a sealed assay test portion.

### BRIEF SUMMARY OF THE INVENTION

It is an object of the urine collection and drug testing cup to provide a cup with an integrated handle that allows simpler collection of the sample. This handle allows a person to collect the sample with less potential for splatter from the urine stream. The handle also provides an easier method of holding and transporting the sample. A tapered cup can be dropped if a person opens their grip and the cup slides through their fingers. If a user places a finger through the hole in the handle of the cup, it reduces the possibility that the cup will be dropped if the user loosens their grip.

It is another object of the urine collection and drug testing cup to provide a flat window portion on the cup that eliminates the parallax effect that can result from viewing through a curved window. The window provides a flat transparent surface to inspect and evaluate the results of the urine testing.

It is another object of the urine collection and drug testing cup to provide the cup with an angled base such that the viewing window exists in a tipped back orientation. This tipped back orientation allows the test strip to be viewed while the cup is sitting on a desk or table that exists at a location that is below the eye level of the person evaluating the test. The angled base with the window provides a tremendous advantage over round cups with tapered sides.

It is another object of the urine collection and drug testing cup to provide a holding mechanism for a test or assaying strip to be placed within the cup. The test strip is placed into the cup when the holder that brings it into a viewing orientation for the flat window.

It is another object of the urine collection and drug testing cup to provide a test area that is sealed with a limiting passage to the collection area. The limited passage allows only a limited amount of liquid to pass from the collection area to the assaying portion. The head pressure of the fluid allows a limited amount of liquid to pass through the passage and creates a pressure pocket in the test assay area of the cup. The pressurized area in the sealed portion of the cup prevents an excessive amount of fluid to enter the test assay area whereby maintaining only a small amount of fluid to make contact with the assay test strip.

It is still another object of the urine collection and drug testing cup to provide a handle, window, test strip holder, and angled base with provisions for a screw-down or snap on lid that allows the cup to be sealed to prevent spilling if the cup is knocked or tipped over.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows an isometric view of the cup with a lid and testing strip.

FIG. 2 shows a side sectional view of the cup showing the internal details and the angled base.

FIG. 3 is another sectional view showing the transfer of fluid from the collection cup to the assay strip.

FIG. 4 shows a view of the cup looking down into the cup.

FIG. 5 shows a front view of the cup showing the front window.

### DETAILED DESCRIPTION

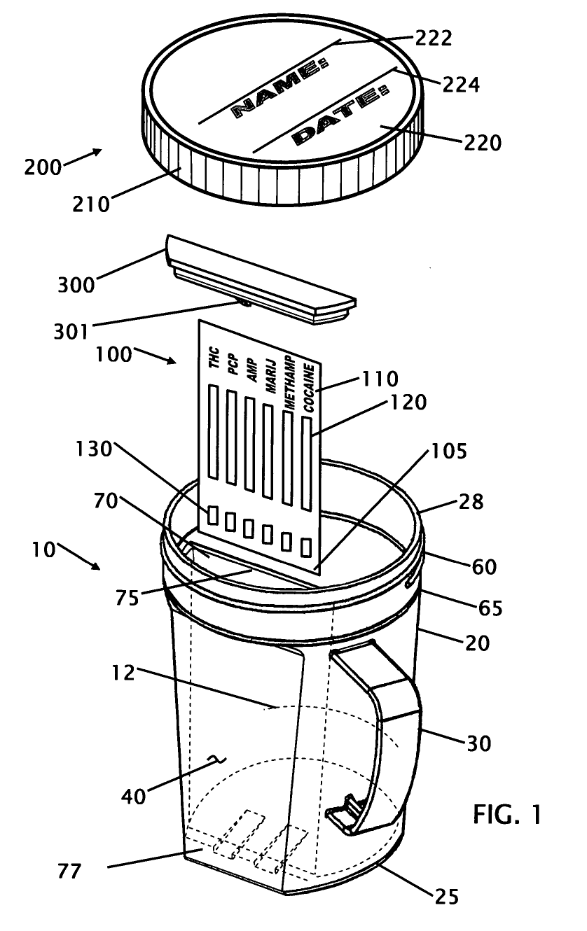

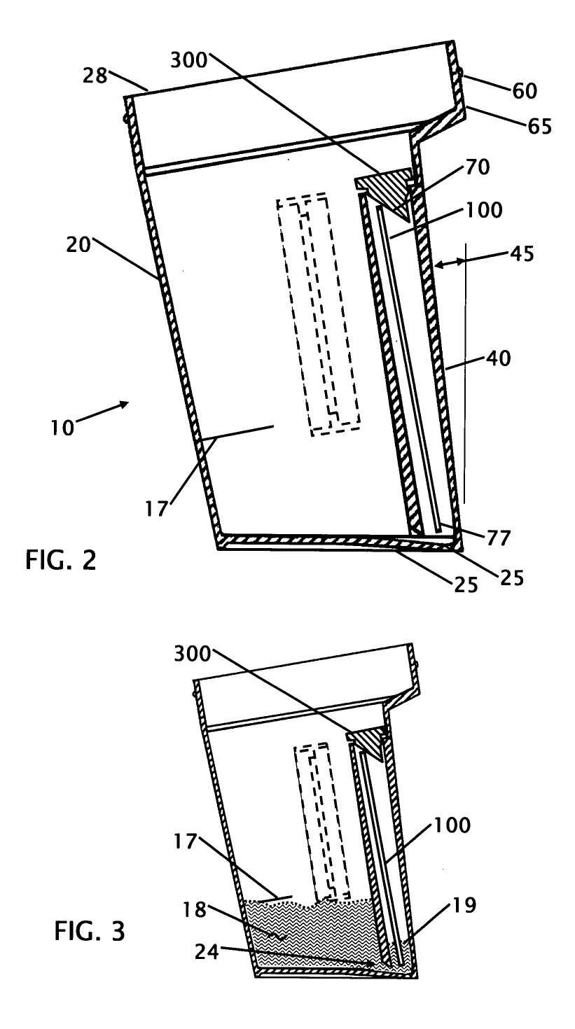

FIG. 1 shows an isometric view of the collection cup or container 10 with a lid 200 and testing or assaying strip 100. In general terms the cup or container is essentially a cylindrical shaped cup starting from the bottom 25 of the cup and sides 20 generally tapering upwards to the upper lip of the cup 28. Referring briefly to FIG. 2 the unique profile of the container can be seen in the side sectional view. Referring back to FIG. 1 the cup rests on the bottom 25 and a essentially flat window portion 40 exists such that the angle formed between the bottom 25 of the container and the window portion of the container 40 forms an acute angle that allows the window 40 to lean back allowing easier viewing of the inside of the container. In the preferred embodiment the acute angle is between 89 and 75 degrees, more preferred at about 85 to 80 degrees and prototypes have been made at 82.5 degrees. The entire cup is made from a transparent or semi-transparent material that allows viewing through the window portion 40 of the container. Materials that satisfy these requirements include but are not limited to plastic, glass, resin, ABS, PVC, acrylic, polyurethane, and polypropylene. In the preferred embodiment the container 40 is made from transparent PVC. The method of fabricating the container includes but is not limited to molding, casting, machining, extruding, drawing or forming process. In the preferred embodiment the fabrication method is injection molding. The window portion of the container 40 may include markings to identify the amount of liquid or urine that is inside the container.

When the cup is assembled the assay strip or strips 100 is placed within the cup 10. An internal cap 300 is placed over the assay strip 100 and bonded into the cup such that the top of the assay portion of the cup is sealed from the collection portion of the cup to prevent collected fluid from entering onto the top of the assaying strip and creating a seal on the top portion of the assay strip portion of the cup. The bottom of the internal cal 300 has one or more tapered fingers 301 to push the assay strip to the back of the window portion of the cup.

The marking(s) 12 on the back side of the cup may provides an indicator for the preferred fluid level 12 in the collection portion of the cup 10. As an example of using the collection cup a person is provided the cup an instructed to collect some urine for the test. The person can hold the handle 30 and deposit a sample of urine into the container with less chance of urinating on their hand that can exist using a collection cup without a handle. After the urine is collected, some of the urine can be poured out of the container to achieve the desired quantity of urine to perform the testing.

The test strip, assaying strip or strips is located in the cup in the area between the window 40 and protrusion(s) 70. A gap 75 exists between or on the sides of the protrusion to allow the urine under test to pass between the collection area and the testing area of the container. A raised area 77 can exist in the bottom of the container to hold the test strip out of the pool of urine. The protrusions keep the strip in close proximity to the window allow the strip to be evaluated by a doctor, technician or other personnel empowered to evaluate the information provided from the test strip.

The test strip 100 includes one or more diagnostic indicators 120 for the presence or drugs or other anomalies in the urine. In operation the bottom of the strip 105 is placed into the container and a sufficient amount of test fluid is transferred into the assay area of the cup. This is shown and described in more detail with FIG. 3. Each test strip includes an absorption area(s) 130 of the strips to absorb sufficient quantities of urine to perform the testing and provide an indicator on one or more panels 120. The strips 100 usually contain an indicator 120 for each type of drug 110 or anomaly that is being tested. The testing may include a thermal indicator and a list of drugs including but not limited to THC, AMP, methamphetamines, morphine, cocaine, PCP, amphetamine, marijuana, and opiates. After the sample can be discarded or the sample can be saved by placing a lid 200 onto the container 100.

The lid can incorporate a variety of closing mechanisms including but not limited to a snap down lid or a screw down lid. In the preferred embodiment the lid is closed with a screw down type lid 200. The screw down lid has serrations or other similar features 210 that exist around the exterior of the lid to aid in gripping the lid for opening and closing the lid onto the container to prevent spilling the contents. The lid may further include a recess on the top of the lid 220 and may further include an area to write the name 222 and or date 224 of the testing for future reference. While the name and date is shown on the lid, the marking can alternately be placed on the side of the container 20 or the test strip 100. When the lid is screwed onto the container it is threaded on the screw features integrated into the container 60. The threaded feature 60 allows the lid to be easily locked down onto the container until the lid locks on the top of the container or onto a raised ridge 65 on the container. A label is alternatively placed on the top or side of the cup to indicate the name, date or number of the test.

FIG. 2 shows a side sectional view of the cup showing the internal details and the angled base. The unique features of the collection cup or container 10 are more easily viewed in this figure where the bottom of the container 25 is shown in a horizontal orientation and the window 40 is shown tipped back at an angle 45 making the viewing of the contents of the container easier when viewed from a position above the container. The outside surface of the collection cup 20 is shown with preferred fluid level indicator 17 placed on the side of the container. While this markings are shown for reference the actual location on the container may vary based upon testing requirements of the assaying strip. It can further be seen from this figure that the inside bottom of the container 23 is lower that the inside bottom where the assaying strip 100 is placed 77. This difference is intended to keep the assaying strip off the bottom of the cup. The screw down ridge(s) 60 is shown extending from the top lip 28 of the upper portion of the container and the bottoming ridge 65 can also be seen in this view. The positioning protrusion(s) 70 on the internal cap 300 is shown behind the face 40 of the viewing window with the assaying strip 100 being held in position.

FIG. 3 is another sectional view showing the transfer of fluid from the collection cup to the assay strip. Note that before the sample is collected the assaying portion of the cup is sealed on the top with the internal cap 300, and the only access to the assay portion of the cup is through one or more small vents 24 that exist on the bottom of the cup. From this figure a sample 18 is collected and the cup is filled to the fill indicator 17. The head pressure of the sample 18 forces some of the sample through the vent 24 and compresses the column of air trapped in the assay portion of the cup. The pressure on the assay portion of the cup limits the amount of sample 19 that can enter into the assay portion of the cup such that it only wets the bottom portion of the assay strip 100.

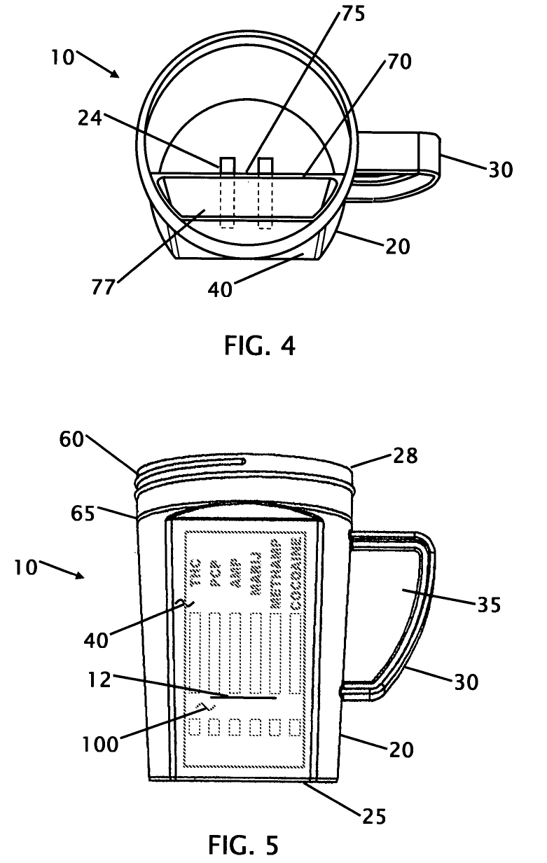

FIG. 4 shows a view of the cup looking down into the cup 10. This view represents what a cup would look like when placed flat on a table, and a portion of the window 40 can be seen when looking down at the container. One handle 30 is shown extending from the side 20 of the cup, but other embodiments are contemplated that provide for handles to be located on two or three sides of the container. The internal protrusion(s) 70 that locate the assaying or test strip within the container are shown with the separation 75 that allows urine to pass into the test area and moisten the assaying strip that can rest on the bottom 77 of the container. The vent passages 24 are shown in this view passing from the collection portion of the cup.

FIG. 5 shows a front view of the cup 10 showing the front window. This view shows the container as it would appear with the bottom 25 sitting flat on a table, desk or counter. The front window 40 is tipped slightly back to allow easier viewing of the assay strip 100 when viewed from an elevated position above the table, desk or counter. The assaying strip is shown as it will appear when viewed through the window 40. A line indicating a preferred fill marking 12 can be seen on the front of the container. While these markings are shown, they may be optionally placed on the container to provide a filling reference and may alternately include text that identifies the markings as such. The handle 30 is shown extending from the side 20 of the cup, where it is attached or connected at two points. This two point connection to the cup allows an opening 35 to exist between the two connection points. The opening makes the container easier to carry and reduces the possibility that the container will be dropped if a person loosens their grip on the outside of the container. The engagement threads 60 are shown to provide for a screw down lid to be secured onto the top 28 of the container. A bottoming lip 65 may further provide a sealing point for the container and may also provide a gripping point for a user.

Thus, specific embodiments and applications for a urine collection and drug testing cup have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A urine collection container comprising:
an essentially transparent fluid holding container in the shape of a cylindrical container with at least one essentially flat window area on a portion of one area on the side of the container wherein the angle formed between the bottom of the container and the essentially flat window is acute,
an internal wall that separates the cup into a collection portion and a test portion wherein the test portion only allows fluid to flow through at least one open vent located proximately to the bottom of cup between the collection portion and the test portion,
the bottom of the fluid holding container is acutely angled such that when the container is placed on the bottom the essentially flat window area on a portion of one area of the side of the fluid holding container is angled back to allow for easier viewing of the internal contents of the container.

2. The urine collection container from claim 1 that further includes at least one protrusion internal to the fluid holding container for locating at least one drug assaying strip.

3. The urine collection container from claim 1 wherein top of the test portion is sealed and creates an air column to limit the amount of fluid that passes though the at least one open vent.

4. The urine collection container from claim 1 that further includes a raised area such that when a drug assay card is placed in the container it does not rest on bottom surface of the inside of the container.

5. The urine collection container from claim 1 that further includes provisions for a screw-down or snap on lid.

6. The urine collection container from claim 1 wherein the container is made from a group of materials selected from of plastic, glass, resin, ABS, PVC, acrylic, polyurethane, or polypropylene.

7. The urine collection container from claim 1 that further includes markings on the side of the container to identify the fluid level within the container.

8. The urine collection container from claim 1 wherein the handle attaches to the container in at least two locations such that at least one open area exists between the at least two attachment locations.

9. The urine collection container from claim 1 wherein the acute angle is between 89 and 75 degrees.

10. The urine collection container from claim 1 that is fabricated from a molding, casting, machining, extruding, drawing or forming process.

11. A fluid collection container comprising:
a collection cup having a liquid sample collection portion;
a testing portion that is separated from the sample collection portion wherein the only passage for fluid from the sample portion to the collection portion is from at least one passage located in proximity to the bottom wall between the testing portion and the sample collection portion.

12. The fluid collection container from claim 11 wherein the testing portion has at least one top cover that seals the upper portion of the testing portion.

13. The fluid collection container from claim 11 that testing portion creates an air column that limits the amount of liquid sample that passes through the at least one passage.

14. The fluid collection container from claim 11 wherein the fluid level in the testing portion is created by an equilibrium between the head pressure in the liquid sample collection portion and the air pressure in testing portion.

15. The fluid collection container from claim 11 wherein the container is made from a group of materials selected from plastic, glass, resin, ABS, PVC, acrylic, polyurethane, or polypropylene.

16. The fluid collection container from claim 11 that further includes at least one handle extending away from the body of the container.

17. The fluid collection container from claim 11 that further includes at least one partially flattened side face.

18. The fluid collection container from claim 17 wherein the at least one partially flattened side face forms an acute angle with the bottom of between 89 and 75 degrees.

19. The fluid collection container from claim 11 that further includes a test strip for testing the at least one parameter of fluid that is collected.

20. The fluid collection container from claim 11 that is fabricated from a molding, casting, machining, extruding, drawing or forming process.
